(19) United States
(12) Patent Application Publication
(10) Pub. No.: US 2021/0172610 A1
(43) Pub. Date: Jun. 10, 2021

(54) OVEN APPLIANCE HAVING A HUMIDITY SENSOR

(71) Applicant: Haier US Appliance Solutions, Inc., Wilmington, DE (US)

(72) Inventors: James Lee Armstrong, Louisville, KY (US); Jordan Kyle Weidner, Louisville, KY (US)

(21) Appl. No.: 16/703,959

(22) Filed: Dec. 5, 2019

(51) Int. Cl. F24C 15/32; F27D 7/02; F24C 7/04

(52) U.S. Cl. CPC F24C 15/327; F27D 7/02; F27D 2019/0012; F24C 15/325; F24C 7/043

(57) ABSTRACT

An oven appliance, as provided herein, may include a cabinet, a ventilation fan, a sensor enclosure, a humidity sensor, and a sensor fan. The cabinet may define a cooking chamber and an oven vent downstream therefrom to direct an exhaust flow from the cooking chamber. The ventilation fan may be mounted to the cabinet downstream from the oven vent. The sensor enclosure may be mounted to the cabinet outside of the cooking chamber. The sensor enclosure may define an enclosed volume. The sensor enclosure may further define an active flow entrance and an active flow exit in fluid communication with the enclosed volume. The humidity sensor may be disposed within the enclosed volume. The sensor fan may be attached to the cabinet outside of the cooking chamber and upstream from the ventilation fan.

### FIELD OF THE INVENTION

The present disclosure relates generally to an oven appliance, or more specifically, to an oven appliance having a humidity sensor for detecting humidity of a cooking chamber.

### BACKGROUND OF THE INVENTION

Oven appliances generally include a cabinet and an insulated cooking chamber disposed therein for receipt of food items for cooking. Heating elements are positioned within the cooking chamber to provide heat to food items located therein. The heating elements can include a bake heating element positioned at a bottom of the cooking chamber or a broil heating element positioned at a top of the cooking chamber. Oven appliances may also include a convection heating assembly, which may include a convection heating element and fan or other mechanism for creating a flow of heated air within the cooking chamber. Some oven appliances may additionally or alternatively include one or more features for generating steam within the cooking chamber. Such steam may help to maintain or increase the moisture in a food item as it is being heated.

Largely independent of the features included in an oven appliance, the humidity level (e.g., percentage or volume of water vapor present in air) within the cooking chamber can significantly impact the cooking process for foods within the cooking chamber. Based on the humidity, airflow or moisture may need to be adjusted (or at least accounted for) while the oven appliance is being used in order to ensure food items are properly cooked. For instance, high humidity in the oven (e.g., represented by an elevated wet-bulb temperature) may increase the thermal conductivity of the air around a food item, leading to a quicker baking process or even burning. Conversely, low humidity may slow a baking process.

Certain challenges exist, however, in measuring or monitoring humidity of a cooking chamber. For instance, most humidity sensors are unable to withstand the high-heat environments of oven cooking chambers. As a result, it is often impractical to try mounting a humidity sensor within a cooking chamber to directly measure humidity. Approximations or guesses may be made about humidity based on ambient conditions and certain measured variables (e.g., temperature) within a cooking chamber. Unfortunately, though, such methods can be prone to inaccuracies. Furthermore, attempts have been made to measure humidity within air from a cooking chamber after it leaves the cooking chamber. These attempts often lead to unsatisfactory results, though, since air from the cooking chamber is often too hot or too significantly impacted by the ambient environment outside of the cooking chamber to obtain an accurate measurement.

As a result, there is a need for measuring the humidity within a cooking chamber. In particular, it would be useful to provide an oven appliance with features for accurately and reliably measuring the humidity of air for a cooking chamber.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, an oven appliance is provided. The oven appliance may include a cabinet, a ventilation fan, a sensor enclosure, a humidity sensor, and a sensor fan. The cabinet may extend along a vertical direction between a top end and a bottom end. The cabinet may extend in a transverse direction from a front end to a rear end. The cabinet may define a cooking chamber and an oven vent downstream therefrom to direct an exhaust flow from the cooking chamber. The ventilation fan may be mounted to the cabinet downstream from the oven vent. The sensor enclosure may be mounted to the cabinet outside of the cooking chamber. The sensor enclosure may define an enclosed volume. The sensor enclosure may further define an active flow entrance and an active flow exit in fluid communication with the enclosed volume. The humidity sensor may be disposed within the enclosed volume. The sensor fan may be attached to the cabinet outside of the cooking chamber and upstream from the ventilation fan.

In another exemplary aspect of the present disclosure, an oven appliance is provided. The oven appliance may include a cabinet, a ventilation fan, a sensor enclosure, a humidity sensor, and a sensor fan. The cabinet may extend along a vertical direction between a top end and a bottom end. The cabinet may extend in a transverse direction from a front end to a rear end. The cabinet may define a cooking chamber and an oven vent downstream therefrom to direct an exhaust flow from the cooking chamber. The ventilation fan may be mounted to the cabinet downstream from the oven vent. The sensor enclosure may be mounted to the cabinet outside of the cooking chamber and forward from the ventilation fan. The sensor enclosure may define an enclosed volume. The sensor enclosure may further define an active flow entrance and an active flow exit in fluid communication with the enclosed volume. The humidity sensor may be disposed within the enclosed volume. The sensor fan may be mounted to the sensor enclosure outside of the cooking chamber and upstream from the ventilation fan.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an oven appliance according to exemplary embodiments of the present disclosure.

FIG. 2 provides a side, sectional view of the exemplary oven appliance of FIG. 1.

FIG. 3 provides a front, sectional view of the exemplary oven appliance of FIG. 1.

FIG. 4 provides a top, plan view of the exemplary oven appliance of FIG. 1, wherein a top panel has been removed for clarity and arrows illustrate an airflow during a non-sensing state of a humidity sensor.

FIG. 5 provides a top, plan view of the exemplary oven appliance of FIG. 1, wherein a top panel has been removed for clarity and arrows illustrate an airflow during a sensing state of a humidity sensor.

FIG. 6 provides a perspective view of a sensor assembly including a sensor enclosure according to exemplary embodiments of the present disclosure.

FIG. 7 provides a perspective view of the sensor enclosure of the exemplary sensor assembly of FIG. 6.

FIG. 8 provides a schematic, plan view of a sensor assembly according to exemplary embodiments of the present disclosure, with arrows illustrating an airflow during a non-sensing state of a humidity sensor.

FIG. 9 provides a schematic, plan view of the exemplary sensor assembly of FIG. 8, with arrows illustrating an airflow during a sensing state of the humidity sensor.

FIG. 10 provides a schematic, plan view of a sensor assembly according to other exemplary embodiments of the present disclosure, with arrows illustrating an airflow during a non-sensing state of a humidity sensor.

FIG. 11 provides a schematic, plan view of the exemplary sensor assembly of FIG. 10, with arrows illustrating an airflow during a sensing state of the humidity sensor.

FIG. 12 provides a schematic, plan view of a sensor assembly according to further exemplary embodiments of the present disclosure, with arrows illustrating an airflow during a non-sensing state of a humidity sensor.

FIG. 13 provides a schematic, plan view of the exemplary sensor assembly of FIG. 12, with arrows illustrating an airflow during a sensing state of the humidity sensor.

FIG. 14 provides a schematic, plan view of a sensor assembly according to still further exemplary embodiments of the present disclosure, with arrows illustrating an airflow during a non-sensing state of a humidity sensor.

FIG. 15 provides a schematic, plan view of the exemplary sensor assembly of FIG. 14, with arrows illustrating an airflow during a sensing state of the humidity sensor.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows.

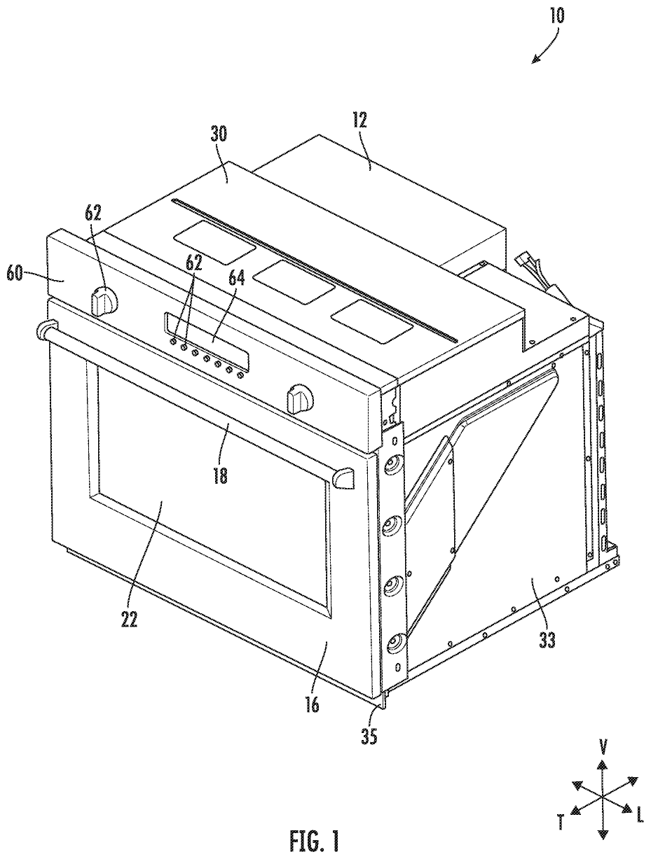

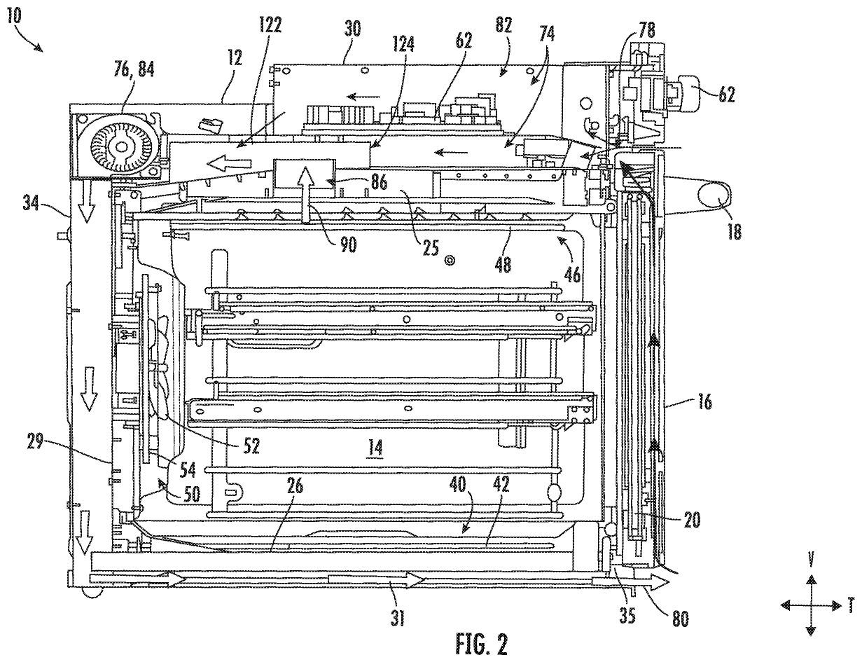

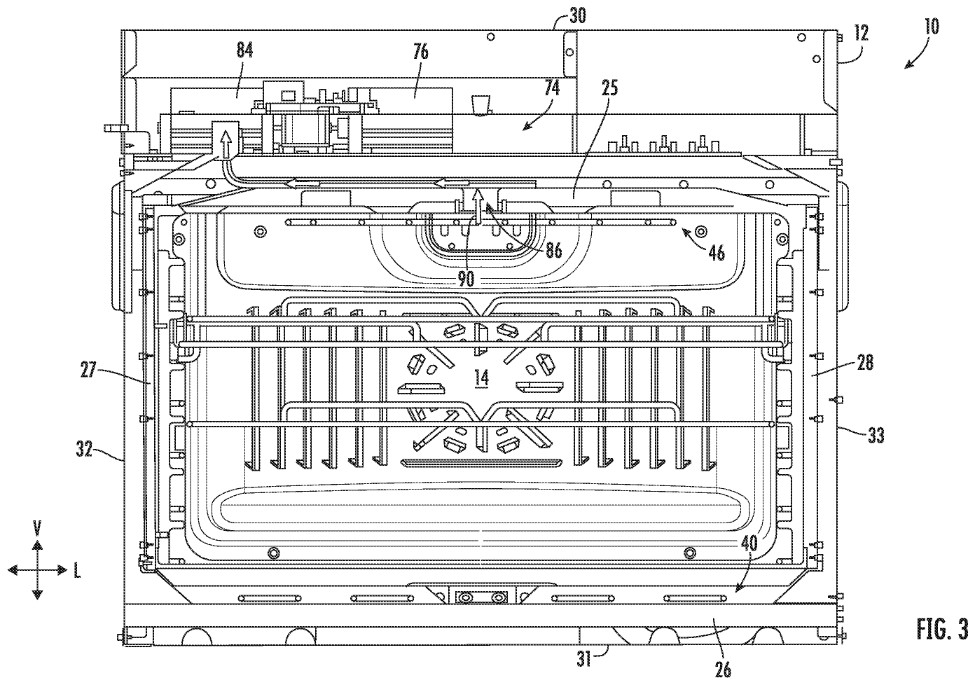

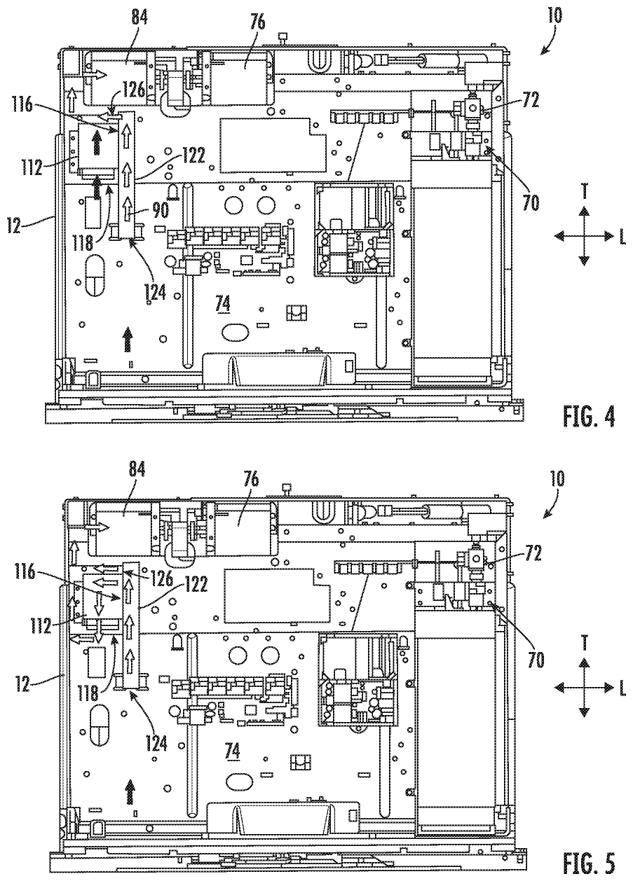

Turning now to the figures, FIGS. 1 through 5 depict an exemplary oven appliance 10 that may be configured in accordance with aspects of the present disclosure. FIG. 1 provides a perspective view of oven appliance 10 according to exemplary embodiments of the present disclosure. FIG. 2 provides a side, sectional view of oven appliance 10. FIG. 3 provides a front, sectional view. FIGS. 4 and 5 provide top, plan views of oven appliance 10.

For the particular embodiment of FIGS. 1 through 5, oven appliance 10 defines a vertical direction V, a lateral direction L, and a transverse direction T. The vertical, lateral, and transverse directions are mutually perpendicular and form an orthogonal direction system. Generally, the exemplary oven appliance 10 of FIG. 5 is configured to be mounted within a building wall, and may thus be described as a wall oven. As will be understood by those skilled in the art, though, oven appliance 10 is provided by way of example only, and the present subject matter may be used in any suitable cooking appliance. Thus, the present subject matter may be used with other oven appliances having different configurations, such as range appliances, double ovens, etc.

Oven appliance 10 includes a cabinet 12 with an insulated cooking chamber 14 disposed within cabinet 12. Insulated cooking chamber 14 is configured for the receipt of one or more food items to be cooked. Oven appliance 10 includes a door 16 rotatably mounted to cabinet 12 (e.g., with a hinge—not shown). A handle 18 is mounted to door 16 and assists a user with opening and closing door 16 in order to access insulated cooking chamber 14. For example, a user can pull on handle 18 to open or close door 16 and access insulated cooking chamber 14.

Oven appliance 10 can include a seal (e.g., gasket 20) between door 16 and cabinet 12 that assists with maintaining heat and cooking fumes within insulated cooking chamber 14 when door 16 is closed as shown. Door 16 may include a window 22, constructed for example from multiple parallel glass panes to provide for viewing the contents of insulated cooking chamber 14 when door 16 is closed and assist with insulating insulated cooking chamber 14. A baking rack may be positioned in insulated cooking chamber 14 for the receipt of food items or utensils containing food items. The baking rack may be slidably received onto embossed ribs or sliding rails such that the baking rack may be conveniently moved into and out of insulated cooking chamber 14 when door 16 is open.

In some embodiments, various sidewalls define insulated cooking chamber 14. For example, insulated cooking chamber 14 includes a top wall 25 and a bottom wall 26, which are spaced apart along the vertical direction V. Left sidewall 27 and right sidewall 28 (as defined according to the view as shown in FIG. 1) extend between the top wall 25 and bottom wall 26, and are spaced apart along the lateral direction L. A rear wall 29 may additionally extend between the top wall 25 and bottom wall 26 as well as between the left sidewall 27 and right sidewall 28, and is spaced apart from door 16 along the transverse direction T. In this manner, when door 16 is in the closed position, a cooking cavity is defined by door 16 and top wall 25, bottom wall 26, left sidewall 27, right sidewall 28, rear wall 29, of insulated cooking chamber 14.

According to the illustrated embodiment, walls 25 through 29 of insulated cooking chamber 14 are depicted as simple blocks of insulating material surrounding the cooking cavity. However, one skilled in the art will appreciate that the insulating material may be constructed of one or more suitable materials and may take any suitable shape. For example, the insulating material may be encased in one or more rigid structural members, such as sheet metal panels, which provide structural rigidity and a mounting surface for attaching, for example, heating elements, temperature probes, rack sliding assemblies, and other mechanical or electronic components.

In a similar manner, cabinet 12 includes multiple panels that enclose insulated cooking chamber 14. For example, cabinet 12 includes a top panel 30 and a bottom panel 31, which are spaced apart along the vertical direction V. Left panel 32 and right panel 33 (as defined according to the view as shown in FIG. 1) extend between the top panel 30 and bottom panel 31, and are spaced apart along the lateral direction L. A rear panel 34 may additionally extend between the top panel 30 and bottom panel 31 as well as between the left panel 32 and right panel 33, and is spaced apart from door 16 along the transverse direction T. When door 16 is in the closed position, door 16 may sit flush with a front panel 35 of cabinet 12.

According to the illustrated embodiments, panels 30 through 35 of cabinet 12 are single ply sheet metal panels, but one skilled in the art will appreciate that any suitably rigid panel may be used while remaining within the scope of the present subject matter. For example, according to an exemplary embodiment, panels 30 through 35 may be constructed from a suitably rigid and thermally resistant plastic. In addition, each panel 30 through 35 may include multiple layers made from the same or different materials, and may be formed in any suitable shape.

In certain embodiments, a lower heating assembly (e.g., bake heating assembly 40) is included in oven appliance 10, and may include one or more heating elements (e.g., bake heating elements 42). Bake heating elements 42 may be disposed within insulated cooking chamber 14, such as adjacent bottom wall 26. In exemplary embodiments, the bake heating elements 42 are electric heating elements, as is generally understood. Alternatively, the bake heating elements 42 may be gas burners or other suitable heating elements having other suitable heating sources. Bake heating elements 42 may generally be used to heat insulated cooking chamber 14 for both cooking and cleaning of oven appliance 10.

In additional or alternative embodiments, an upper heating assembly (e.g., broil heating assembly 46) is included in oven appliance 10, and may include one or more upper heating elements (e.g., broil heating elements 48). Broil heating elements 48 may be disposed within insulated cooking chamber 14, such as adjacent top wall 25. In exemplary embodiments, the broil heating elements 48 are electric heating elements, as is generally understood. Alternatively, the broil heating elements 48 may be gas burners or other suitable heating elements having other suitable heating sources. Broil heating elements 48 may additionally generally be used to heat insulated cooking chamber 14 for both cooking and cleaning of oven appliance 10.

Oven appliance 10 may also include a convection heating assembly 50. Convection heating assembly 50 may have a fan 52 and, optionally, a convection heating element 54. Convection heating assembly 50 is configured for selectively urging a flow of heated air into insulated cooking chamber 14. For example, fan 52 can pull air from insulated cooking chamber 14 into convection heating assembly 50 and convection heating element 54 can heat such air. Subsequently, fan 52 can urge such heated air back into insulated cooking chamber 14. As another example, fan 52 can cycle heated air from insulated cooking chamber 14 within insulated cooking chamber 14 in order to generate forced convective air currents without use of convection heating element 54. Like heating elements 42, 48 discussed above, convection heating element 54 may be, for example, a gas, electric, or microwave heating element or any suitable combination thereof. According to an alternative exemplary embodiment, convection heating assembly 50 need not include fan 52.

In optional embodiments, a steam-injection assembly 70 is provided to selectively direct or release water to insulated cooking chamber 14. For instance, a water valve 72 may be mounted on or within cabinet 12 upstream from cooking chamber 14 and downstream from a water source or reservoir. During use, water valve 72 may be selectively opened, thereby permitting water to flow to insulated cooking chamber 14. Within cooking chamber 14, water may be vaporized (e.g., by the heat generated by heating assembly 40, 46, or 50). Steam may thus be provided to cooking chamber 14.

As shown, oven appliance 10 may be provided with a cooling system whereby ambient air is used to help cool oven appliance 10. For example, one or more cooling air flow passageways 74 may be formed within cabinet 12, such as by adjacent walls or panels 25 through 35 of oven appliance 10. In some embodiments, cooling air flow passageway 74 wraps around cooking chamber 14 to provide convective cooling to walls or panels 25 through 35 and prevent overheating of cabinet 12. Optionally, cooling air flow passageway 74 may extend from front panel 35 of oven appliance 10, across top wall 25, down rear wall 29, and along bottom wall 26 back to the front of cabinet 12. Nonetheless, as will be understood in light of the present disclosure, cooling air flow passageway 74 may have a variety of configurations other than as shown.

During use, a cooling fan 76 (e.g., mounted within cabinet 12) can be selectively activated to move air through passageway 74. As shown, cooling fan 76 is provided in fluid communication between a discrete airflow entrance 78 and airflow exit 80 defined by cabinet 12 and spaced apart from each other. In other words, cooling fan 76 is mounted downstream from airflow entrance 78 and upstream from airflow exit 80. Thus, cooling fan 76 may draw ambient air through airflow entrance 78 (e.g., positioned between door 16 and user interface panel 60). In some embodiments, cooling fan 76 also pulls this cooler, ambient air through an electronics bay 82 (e.g., housing controller 58), which is connected with cooling air flow passageway 74. After flowing past walls or panels 25 through 35 to provide convective cooling, the air exits passageway 74 through cooling airflow exit 80.

Generally, cooling fan 76 may be any fan or device suitable for urging air flow through cooling air flow passageway 74. For instance, cooling fan 76 may be a tangential fan positioned within cooling air flow passageway 74 (e.g., at a rear portion of cabinet 12 or adjacent to top wall 25). Nonetheless, it is understood that alternative types of fans, locations, and configurations are also possible and within the scope of the present disclosure. Separate from or in addition to cooling fan 76, a ventilation fan 84 may be mounted to cabinet 12 downstream from an oven vent 86. Generally, oven vent 86 is defined by cabinet 12 (e.g., through top wall 25) downstream from cooking chamber 14 to direct an exhaust flow 90 from cooking chamber 14. For instance, oven vent 86 may be defined by a conduit that extends generally along the vertical direction V (e.g., along a linear or curved path upward) from cooking chamber 14. Ventilation fan 84 is mounted downstream from oven vent 86 and can motivate the exhaust flow 90 from cooking chamber 14. During use, the air withdrawn from cooking chamber 14 within exhaust flow 90 is replaced by ambient air drawn into cooking chamber 14 through the gasket 20 between door 16 and walls or panels 25 through 35. Notably, such ventilation of cooking chamber 14 may remove, for example, some of the moisture and gases released during cooking operations.

Generally, ventilation fan 84 may be any fan or device suitable for urging exhaust flow 90 through from oven vent 86 through cabinet 12. For instance, ventilation fan 84 may be a tangential fan positioned within cabinet 12 (e.g., at a rear portion of cabinet 12 or adjacent to top wall 25). In some embodiments, ventilation fan 84 is mounted within passageway 74 (e.g., upstream from airflow exit 80). For instance, ventilation fan 84 may be mounted in parallel (e.g., fluid or mechanical parallel) to cooling fan 76. Optionally, ventilation fan 84 and cooling fan 76 may be motivated by a common motor (e.g., such that the fans 76, 84 are activated and rotate in tandem). Nonetheless, it is understood that alternative types of fans, locations, and configurations are also possible and within the scope of the present disclosure.

Oven appliance 10 is further equipped with a controller 58 to regulate operation of the oven appliance 10. For example, controller 58 may regulate the operation of oven appliance 10 including heating elements 42, 48, 54 (and heating assemblies 40, 46, 50 generally), steam-injection assembly 70, or fans 76, 84. Controller 58 may be in operable communication (via for example a suitable wired or wireless connection) with the heating elements 42, 48, 54, steam-injection assembly 70, fans 76, 84, and other suitable components of the oven appliance 10, as discussed herein. In general, controller 58 may be operable to configure the oven appliance 10 (and various components thereof) for cooking. Such configuration may be based on a plurality of cooking factors of a selected operating cycles, sensor feedback, etc.

By way of example, controller 58 may include one or more memory devices and one or more microprocessors, such as general or special purpose microprocessors operable to execute programming instructions or micro-control code associated with an operating cycle. The memory may represent random access memory such as DRAM, or read only memory such as ROM or FLASH. In one embodiment, the processor executes programming instructions stored in memory. The memory may be a separate component from the processor or may be included onboard within the processor.

Controller 58 may be positioned in a variety of locations throughout oven appliance 10. In the illustrated embodiment, controller 58 may be located within a user interface panel 60 of oven appliance 10 as shown in FIG. 2. In such an embodiment, input/output (“I/O”) signals may be routed between the control system and various operational components of oven appliance 10 along wiring harnesses that may be routed through cabinet 12. Typically, controller 58 is in operable communication (e.g., wired or wireless communication) with user interface panel 60 and controls 62 through which a user may select various operational features and modes and monitor progress of oven appliance 10. In one embodiment, user interface panel 60 may represent a general purpose I/O (“GPIO”) device or functional block. In one embodiment, user interface panel 60 may include input components or controls 62, such as one or more of a variety of electrical, mechanical or electro-mechanical input devices including rotary dials, push buttons, and touch pads. User interface panel 60 may include a display component, such as a digital or analog display device 64 designed to provide operational feedback to a user.

User interface panel 60 may be in operable communication with controller 58 via one or more signal lines or shared communication busses. Controller 58 may also be communication with one or more sensors. As an example, controller 58 may be in operable communication with a temperature sensor that is used to measure temperature inside insulated cooking chamber 14 and provide such measurements to controller 58. The temperature sensor may be a thermocouple, a thermistor, a resistance temperature detector, or any other device suitable for measuring the temperature within insulated cooking chamber 14. In this manner, controller 58 may selectively control heating elements 42, 48, 54 or steam-injection assembly 70 in response to user manipulation of user interface panel 60 and temperature feedback from the temperature sensor. Controller 58 can also receive temperature measurements from the temperature sensor placed within insulated cooking chamber 14 and, for example, provide a temperature indication to the user with display 64.

As an additional or alternative example, controller 58 may be in operable communication with a humidity sensor 110 that is mounted outside of cooking chamber 14, yet may provide a measurement of humidity inside insulated cooking chamber 14, as will be described below. Humidity sensor 110 may be provided as a hygrometer, such as a thermal hygrometer, optical hygrometer, capacitive hygrometer, or any other device suitable for measuring the humidity of air from cooking chamber 14. Once obtained (e.g., at controller 58 or off controller 58), such humidity measurements may be provided to and used by controller 58. In this manner, controller 58 may selectively control heating elements 42, 48, 54 or steam-injection assembly 70 in response to user manipulation of user interface panel 60 and humidity feedback from the humidity sensor 110. Controller 58 can also obtain humidity measurements and, for example, provide a humidity indication to the user with display 64.

In certain embodiments, humidity sensor 110 is housed, at least in part, within a sensor enclosure 112. Specifically, humidity sensor 110 may be disposed within an enclosed volume 114 defined by sensor enclosure 112 (e.g., by one or more sidewalls and top wall 25 with or without a solid surface of the cabinet 12 to which sensor enclosure 112 is mounted). As shown, sensor enclosure 112 is generally mounted to cabinet 12 outside of cooking chamber 14. Thus, sensor enclosure 112 is fixed to cabinet 12 while being positioned away from the high-heat environment created within cooking chamber 14 during cooking or heating operations. In some embodiments, sensor enclosure 112 is attached to an insulated wall (e.g., 25 through 29). For example, sensor enclosure 112 may be attached to an outer surface of top wall 25 above cooking chamber 14. Insulation may thus be positioned between sensor enclosure 112 and cooking chamber 14 such that conductive heat transfer between sensor enclosure 112 and cooking chamber 14 is prevented.

Along with defining an enclosed volume 114, sensor enclosure 112 further defines a discrete active flow entrance 116 and active flow exit 118. Active flow entrance 116 and active flow exit 118 are spaced apart from each other (e.g., at different sidewalls or ends of sensor enclosure 112). In some embodiments, active flow entrance 116 is defined along the lateral direction L. For instance, active flow entrance 116 may be defined on a lateral sidewall of sensor enclosure 112. In additional or alternative embodiments, active flow exit 118 faces away from ventilation fan 84 (e.g., forward). For instance, active flow exit 118 may be defined along the transverse direction T or the lateral direction L at a forward end of sensor enclosure 112.

As shown, both active flow entrance 116 and active flow exit 118 are in in fluid communication with enclosed volume 114 such that air can pass therebetween. Optionally, active flow entrance 116 may be defined as an unobstructed hole or opening extending through a wall of sensor enclosure 112 to enclosed volume 114. Additionally or alternatively, active flow exit 118 may be defined as a separate unobstructed hole or opening extending through a wall of sensor enclosure 112 to enclosed volume 114.

When assembled, humidity sensor 110 (and thus at least a portion of sensor enclosure 112) is spaced apart from oven vent 86. In some such embodiments, humidity sensor 110 and enclosed volume 114 are spaced apart from the terminal end or aperture of oven vent 86 (e.g., opposite of cooking chamber 14) in a direction perpendicular to the vertical direction V (e.g., the lateral direction L or the transverse direction T). In other words, humidity sensor 110 is horizontally offset from oven vent 86. Thus, heated air or fluid exiting oven vent 86 from cooking chamber 14 or through a sidewall is unable to flow immediately to humidity sensor 110. As shown, humidity sensor 110 may be positioned rearward from oven vent 86 such that air or fluid from oven vent 86 must travel, at least in part, along the transverse direction T toward the rear end of cabinet 12 before reaching humidity sensor 110 or sensor enclosure 112. Additionally or alternatively, humidity sensor 110 may be positioned sideways from oven vent 86 such that air or fluid from oven vent 86 must travel, at least in part, along the lateral direction L toward the first side or, alternatively, the second side of cabinet 12 before reaching humidity sensor 110 or sensor enclosure 112.

In some embodiments, a duct 112 is provided downstream from oven vent 86 to direct at least a portion of air or fluid from oven vent 86. Specifically, duct 112 may be mounted to cabinet 12 above oven vent 86 to receive the exhaust flow 90 from oven vent 86. For instance, duct 112 may be mounted to the outer surface of an insulated wall at which oven vent 86 terminates (e.g., top wall 25). As shown, along with a channel for guiding air or fluid (e.g., exhaust flow 90), duct 112 may define a discrete air inlet 124 and air outlet 126. Generally, air inlet 124 is defined upstream from the terminating end of oven vent 86 within duct 112 while air outlet 126 is defined downstream from the same. During use, at least a portion of exhaust flow 90 may thus travel through duct 112 to air outlet 126 with at least a portion of ambient air passed to duct 112 from air inlet 124. When assembled, air inlet 124 may be defined or disposed forward from oven vent 86 or sensor enclosure 112. Additionally or alternatively, air outlet 126 may be disposed rearward from oven vent 86.

Generally, at least a portion of air outlet 126 is directed at sensor enclosure 112. At least a portion of exhaust flow 90 may thus be directed from duct 112 to sensor enclosure 112. In optional embodiments, air outlet 126 defines at least two discrete outlet paths 128, 130. A first outlet path 128 may be defined at or proximate to active flow entrance 116. In turn, air or fluid is permitted between duct 112 and sensor enclosure 112 along first outlet path 128 through air outlet 126 and active flow entrance 116. A second outlet path 130 may be defined apart from (e.g., behind or rearward from) active flow entrance 116. In turn, air or fluid is permitted from duct 112 along second outlet path 130 through air outlet 126 without passing to sensor enclosure 112. Thus, air or fluid along second outlet path 130 bypasses active flow entrance 116 and enclosed volume 114. For instance, such air or fluid along second outlet path 130 may pass to ventilation fan 84 while bypassing active flow entrance 116 and enclosed volume 114. Separate from or in addition to ventilation fan 84, oven appliance 10 may include a sensor fan 132 attached to cabinet 12 outlet of cooking chamber 14. In particular, sensor fan 132 may be disposed upstream from ventilation fan 84. During certain operations, at least a portion of air received at ventilation fan 84 may thus pass over or across sensor fan 132. In some such embodiments, sensor fan 132 is positioned to communicate with or direct air through enclosed volume 114. For instance, sensor fan 132 may be mounted to sensor enclosure 112.

Generally, sensor fan 132 may be any fan or device suitable for urging exhaust flow 90 through from active flow entrance 116 to active flow exit 118. For instance, ventilation fan 84 may be an axial fan positioned coaxially with active flow exit 118. In certain embodiments, sensor fan 132 is mounted in fluid communication (e.g., along a fluid communication flow path) between active flow entrance 116 and active flow exit 118. Air through enclosed volume 114 may pass over or across sensor fan 132. In further embodiments, sensor fan 132 is mounted in fluid communication between humidity sensor 110 and active flow exit 118. Air may thus pass from humidity sensor 110 and across or through sensor fan 132 before passing to active flow exit 118. Nonetheless, it is understood that alternative types of fans, locations, and configurations are also possible and within the scope of the present disclosure.

When assembled, sensor fan 132 may be in operable communication with controller 58. Controller 58 may be configured to selectively activate or rotate sensor fan 132 (e.g., as part of a sensing state for humidity sensor 110). For instance, sensor fan 132 may be activated independently of ventilation fan 84. As ventilation fan 84 rotates, sensor fan 132 may be alternately activated and deactivated. When activated or rotating (e.g., in an sensing state) during use of oven appliance 10 (e.g., while a heating element 42, 48, 54; ventilation fan 84; or cooling fan 76 remains active), sensor fan 132 may motivate an active flow through sensor enclosure 112. Specifically, the active flow may be drawn from active flow entrance 116 to active flow exit 118 and include, at least a portion of the exhaust flow 90 from oven vent 86 (e.g., exiting air outlet 126). From the active flow, humidity sensor 110 may advantageously measure humidity from exhaust flow 90 before exhaust flow 90 has significantly dispersed (e.g., without subjecting humidity sensor 110 to extreme temperatures). By contrast, when sensor fan 132 is not activated (e.g., in a non-sensing state) during use of oven appliance 10 (e.g., while a heating element 42, 48, 54; ventilation fan 84; or cooling fan 76 remains active), a passive airflow may be motivated through sensor enclosure 112. Specifically, the passive airflow may be drawn from active flow exit 118 to active flow entrance 116 (e.g., prior to flowing to duct 112 through air outlet 126). The passive airflow may be motivated by natural convection or, alternatively, ventilation or cooling fans 76, 84. Separately or in addition to the passive airflow, air may be motivated (e.g., by ventilation or cooling fans 84, 76) over or around sensor enclosure 112 without passing through enclosed volume 114.

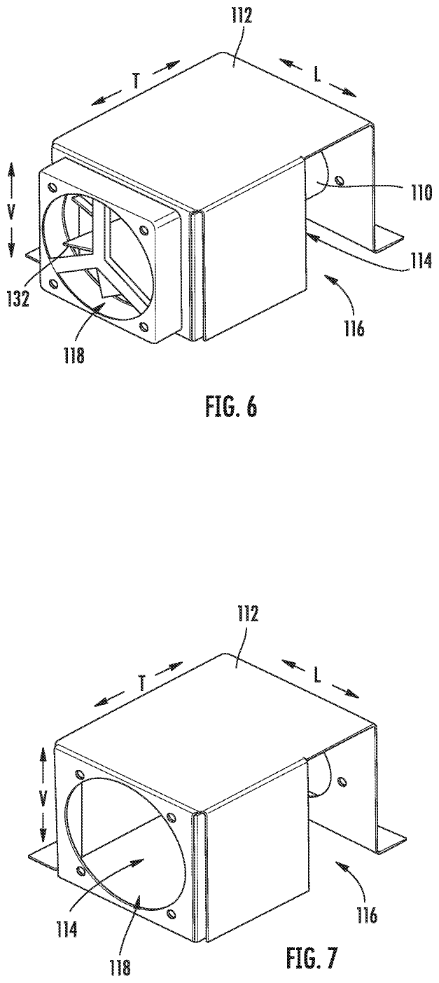

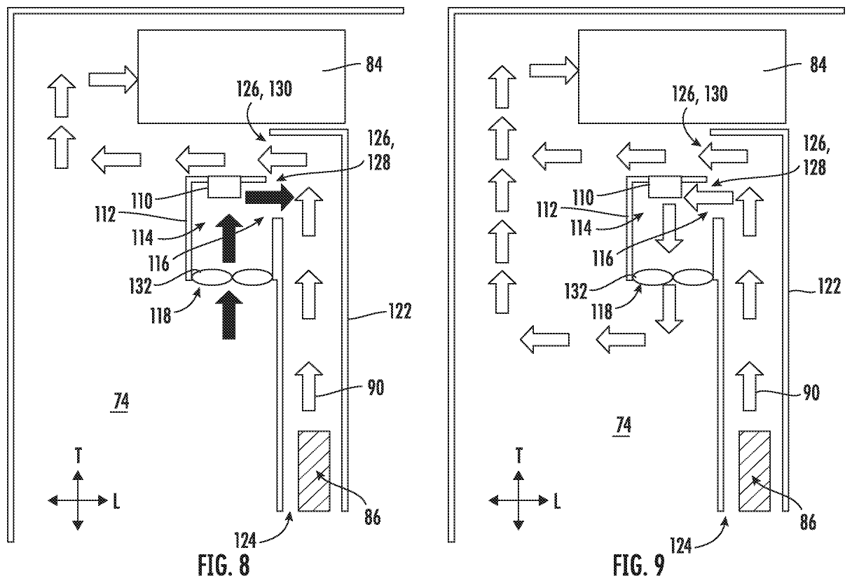

Turning now to FIGS. 8 and 9, schematic views are provided of sensor enclosure 112 to illustrate the active flow and passive airflow, respectively, according to exemplary embodiments, such as those illustrated in FIGS. 2 through 7. As shown, active flow entrance 116 may be defined along the lateral direction L (e.g., from duct 112 as part of first outlet path 128 of air outlet 126). Active flow exit 118 may face forward, away from ventilation fan 84, and be defined along the transverse direction T.

In the non-sensing state (e.g., FIG. 8) of sensor 110, the passive airflow may enter sensor enclosure 112 through active flow exit 118 and pass to enclosed volume 114. From enclosed volume 114, the passive airflow may pass from a surrounding portion of cabinet 12 through active flow entrance 116 (e.g., to duct 112). After exiting sensor enclosure 112, the passive airflow may mix or entrain with a separate airflow (e.g., within duct 112) before passing from cabinet 12 (e.g., as motivated by or through ventilation fan 84).

In the sensing state (e.g., FIG. 9) of sensor 110, the active flow may enter sensor enclosure 112 from oven vent 86 or duct 112 through active flow entrance 116 and pass to enclosed volume 114. As noted above, within sensor enclosure 112, humidity sensor 110 may measure humidity for air from cooking chamber 14. From enclosed volume 114, the active flow may pass through active flow exit 118 (e.g., to a surrounding portion of cabinet 12). After exiting sensor enclosure 112, the active flow may mix or entrain with a separate airflow (e.g., having exiting duct 112 through the second outlet path 130 of air outlet 126) before passing from cabinet 12 (e.g., as motivated by or through ventilation fan 84).

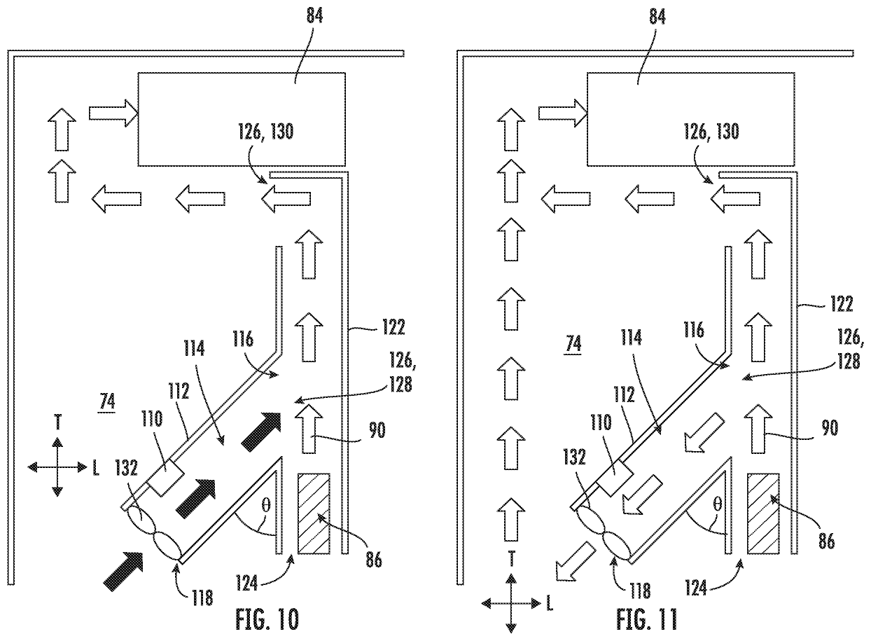

Turning now to FIGS. 10 and 11, schematic views are provided of sensor enclosure 112 to illustrate the active flow and passive airflow, respectively, according to other exemplary embodiments. As shown, active flow entrance 116 may be defined along the lateral direction L (e.g., from duct 112 as part of first outlet path 128 of air outlet 126). Sensor enclosure 112 may be a linear enclosure defining enclosure volume along a linear path extending from duct 112 at a primary non-orthogonal angle θ (e.g., greater than 0° and less than 90°, such as 45°) relative to the transverse direction T. Active flow exit 118 may face away from ventilation fan 84 at the primary non-orthogonal angle θ.

In the non-sensing state (e.g., FIG. 10) of sensor 110, the passive airflow may enter sensor enclosure 112 through active flow exit 118 and pass to enclosed volume 114. From enclosed volume 114, the passive airflow may pass from a surrounding portion of cabinet 12 through active flow entrance 116 (e.g., to duct 112). After exiting sensor enclosure 112, the passive airflow may mix or entrain with a separate airflow (e.g., within duct 112) before passing from cabinet 12 (e.g., as motivated by or through ventilation fan 84).

In the sensing state (e.g., FIG. 11) of sensor 110, the active flow may enter sensor enclosure 112 from oven vent 86 or duct 112 through active flow entrance 116 and pass to enclosed volume 114. As noted above, within sensor enclosure 112, humidity sensor 110 may measure humidity for air from cooking chamber 14. From enclosed volume 114, the active flow may pass through active flow exit 118 (e.g., to a surrounding portion of cabinet 12). After exiting sensor enclosure 112, the active flow may mix or entrain with a separate airflow (e.g., having exiting duct 112 through the second outlet path 130 of air outlet 126) before passing from cabinet 12 (e.g., as motivated by or through ventilation fan 84).

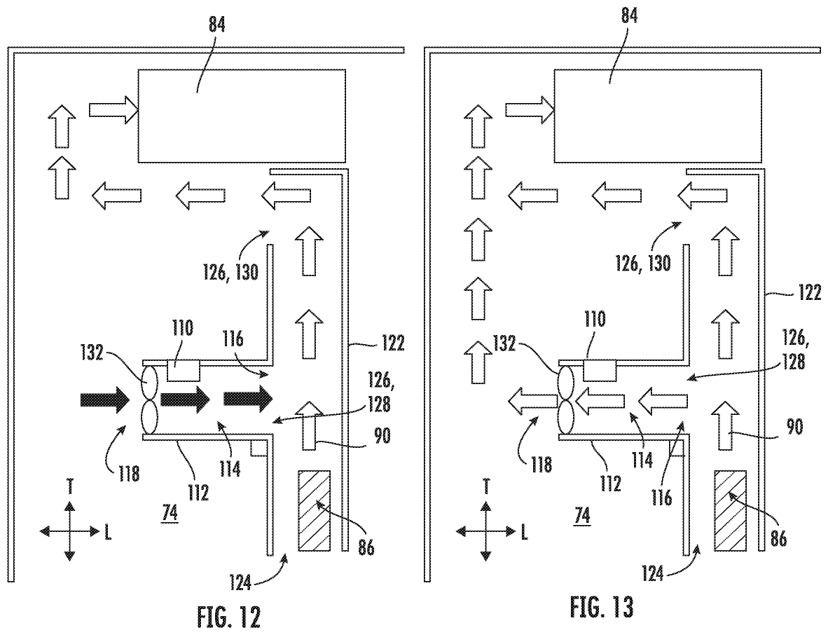

Turning now to FIGS. 12 and 13, schematic views are provided of sensor enclosure 112 to illustrate the active flow and passive airflow, respectively, according to further alternative exemplary embodiments. As shown, active flow entrance 116 may be defined along the lateral direction L (e.g., from duct 112 as part of first outlet path 128 of air outlet 126). Sensor enclosure 112 may be a linear enclosure defining enclosure volume along a linear path extending from duct 112 at an orthogonal angle relative to the transverse direction T. Active flow exit 118 may face away from ventilation fan 84 and be defined along the lateral direction L while being laterally spaced apart from active flow exit 118.

In the non-sensing state (e.g., FIG. 12) of sensor 110, the passive airflow may enter sensor enclosure 112 through active flow exit 118 and pass to enclosed volume 114. From enclosed volume 114, the passive airflow may pass from a surrounding portion of cabinet 12 through active flow entrance 116 (e.g., to duct 112). After exiting sensor enclosure 112, the passive airflow may mix or entrain with a separate airflow (e.g., within duct 112) before passing from cabinet 12 (e.g., as motivated by or through ventilation fan 84).

In the sensing state (e.g., FIG. 13) of sensor 110, the active flow may enter sensor enclosure 112 from oven vent 86 or duct 112 through active flow entrance 116 and pass to enclosed volume 114. As noted above, within sensor enclosure 112, humidity sensor 110 may measure humidity for air from cooking chamber 14. From enclosed volume 114, the active flow may pass through active flow exit 118 (e.g., to a surrounding portion of cabinet 12). After exiting sensor enclosure 112, the active flow may mix or entrain with a separate airflow (e.g., having exiting duct 112 through the second outlet path 130 of air outlet 126) before passing from cabinet 12 (e.g., as motivated by or through ventilation fan 84).

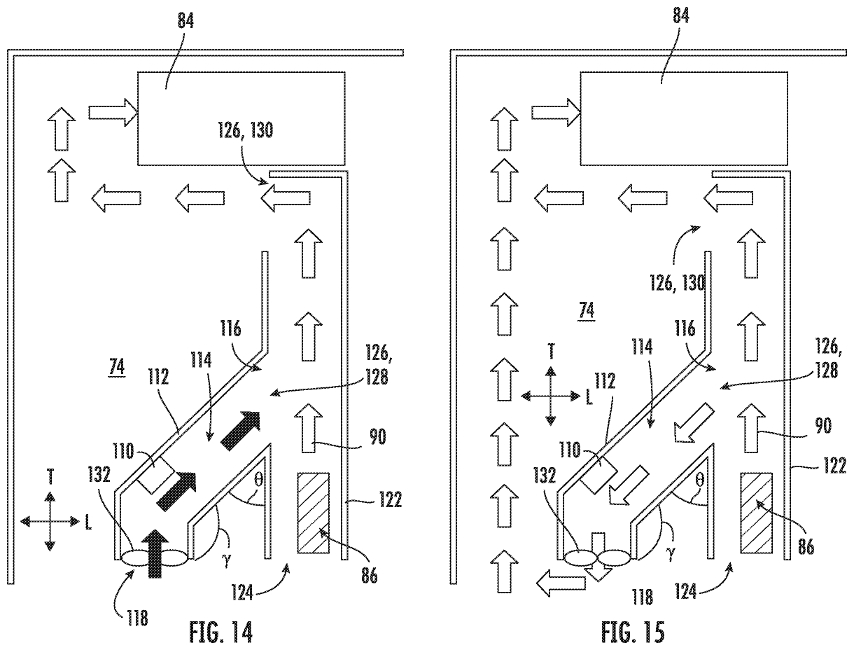

Turning now to FIGS. 14 and 15, schematic views are provided of sensor enclosure 112 to illustrate the active flow and passive airflow, respectively, according to still further exemplary embodiments. As shown, active flow entrance 116 may be defined along the lateral direction L (e.g., from duct 112 as part of first outlet path 128 of air outlet 126). Sensor enclosure 112 may be a bent or curved enclosure. Enclosed volume 114 may thus be bent or curved (e.g., from duct 112). For instance, sensor enclosure 112 may extend from duct 112 at a primary non-orthogonal angle θ (e.g., greater than 0° and less than 90°, such as 45°) relative to the transverse direction T. Sensor enclosure 112 may further extend forward (e.g., back toward duct 112) at a secondary angle γ (e.g., greater than 0° and less than 180°, such as 135°). Optionally, the secondary angle γ and primary non-orthogonal angle θ may equal 180°. Active flow exit 118 may thus face forward, away from ventilation fan 84, and be defined along the transverse direction T.

In the non-sensing state (e.g., FIG. 13) of sensor 110, the passive airflow may enter sensor enclosure 112 through active flow exit 118 and pass to enclosed volume 114. From enclosed volume 114, the passive airflow may pass from a surrounding portion of cabinet 12 through active flow entrance 116 (e.g., to duct 112). After exiting sensor enclosure 112, the passive airflow may mix or entrain with a separate airflow (e.g., within duct 112) before passing from cabinet 12 (e.g., as motivated by or through ventilation fan 84).

In the sensing state (e.g., FIG. 14) of sensor 110, the active flow may enter sensor enclosure 112 from oven vent 86 or duct 112 through active flow entrance 116 and pass to enclosed volume 114. As noted above, within sensor enclosure 112, humidity sensor 110 may measure humidity for air from cooking chamber 14. From enclosed volume 114, the active flow may pass through active flow exit 118 (e.g., to a surrounding portion of cabinet 12). After exiting sensor enclosure 112, the active flow may mix or entrain with a separate airflow (e.g., having exiting duct 112 through the second outlet path 130 of air outlet 126) before passing from cabinet 12 (e.g., as motivated by or through ventilation fan 84).

It is noted that although various exemplary shapes of sensor enclosure 112 are illustrated in FIGS. 9 through 15, such examples are not exhaustive. Any other suitable shape may be provided, as would be understood in light of the present disclosure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An oven appliance defining a mutually-orthogonal vertical direction, lateral direction, and transverse direction, the oven appliance comprising:
a cabinet extending along the vertical direction between a top end and a bottom end, the cabinet extending in the transverse direction from a front end to a rear end, the cabinet defining a cooking chamber and an oven vent downstream therefrom to direct an exhaust flow from the cooking chamber;
a ventilation fan mounted to the cabinet downstream from the oven vent;
a sensor enclosure mounted to the cabinet outside of the cooking chamber, the sensor enclosure defining an enclosed volume, the sensor enclosure further defines an active flow entrance and an active flow exit in fluid communication with the enclosed volume;
a humidity sensor disposed within the enclosed volume; and
a sensor fan attached to the cabinet outside of the cooking chamber and upstream from the ventilation fan.

2. The oven appliance of claim 1, wherein the humidity sensor is spaced apart from the oven vent in a direction perpendicular to the vertical direction.

3. The oven appliance of claim 2, wherein the humidity sensor is spaced apart from the oven vent along the transverse direction.

4. The oven appliance of claim 2, wherein the humidity sensor is spaced apart from the oven vent along the lateral direction.

5. The oven appliance of claim 2, further comprising a duct mounted to the cabinet above the oven vent to receive the exhaust flow from the oven vent, the duct defining an air inlet and an air outlet, the air inlet being disposed forward from the oven vent, and the air outlet being disposed rearward from the oven vent at the sensor enclosure.

6. The oven appliance of claim 1, wherein the active flow entrance is defined along the lateral direction.

7. The oven appliance of claim 1, wherein the active flow exit is defined along the transverse direction facing forward.

8. The oven appliance of claim 1, wherein the cabinet extends along the lateral direction between a first side end and a second side end, wherein a first and second ancillary airflow paths are defined along the transverse direction above the cooking chamber and outside of the enclosed volume, wherein the first ancillary airflow path is defined between the first side end and the sensor enclosure, and wherein the second ancillary airflow path is defined between the second side end and the sensor enclosure.

9. The oven appliance of claim 1, wherein the sensor fan is mounted to the sensor enclosure in fluid communication between the active flow entrance and the active flow exit.

10. The oven appliance of claim 9, wherein the sensor fan is mounted in fluid communication between the humidity sensor and the active flow exit.

11. An oven appliance defining a mutually-orthogonal vertical direction, lateral direction, and transverse direction, the oven appliance comprising:
a cabinet extending along the vertical direction between a top end and a bottom end, the cabinet extending in the transverse direction from a front end to a rear end, the cabinet defining a cooking chamber and an oven vent downstream therefrom to direct an exhaust flow from the cooking chamber;
a ventilation fan mounted to the cabinet downstream from the oven vent;
a sensor enclosure mounted to the cabinet outside of the cooking chamber and forward from the ventilation fan, the sensor enclosure defining an enclosed volume, the sensor enclosure further defines an active flow entrance and an active flow exit in fluid communication with the enclosed volume;
a humidity sensor disposed within the enclosed volume; and
a sensor fan mounted to the sensor enclosure outside of the cooking chamber and upstream from the ventilation fan.

12. The oven appliance of claim 11, wherein the humidity sensor is spaced apart from the oven vent in a direction perpendicular to the vertical direction.

13. The oven appliance of claim 12, wherein the humidity sensor is spaced apart from the oven vent along the transverse direction.

14. The oven appliance of claim 12, wherein the humidity sensor is spaced apart from the oven vent along the lateral direction.

15. The oven appliance of claim 12, further comprising a duct mounted to the cabinet above the oven vent to receive the exhaust flow from the oven vent, the duct defining an air inlet and an air outlet, the air inlet being disposed forward from the oven vent, and the air outlet being disposed rearward from the oven vent at the sensor enclosure.

16. The oven appliance of claim 11, wherein the active flow entrance is defined along the lateral direction.

17. The oven appliance of claim 11, wherein the active flow exit is defined along the transverse direction facing forward.

18. The oven appliance of claim 11, wherein the cabinet extends along the lateral direction between a first side end and a second side end, wherein a first and second ancillary airflow paths are defined along the transverse direction above the cooking chamber and outside of the enclosed volume, wherein the first ancillary airflow path is defined between the first side end and the sensor enclosure, and wherein the second ancillary airflow path is defined between the second side end and the sensor enclosure.

19. The oven appliance of claim 11, wherein a sensor fan is mounted in fluid communication between the humidity sensor and the active flow exit.
